(19) United States
(12) Patent Application Publication
(10) Pub. No.: US 2016/0023165 A1
(43) Pub. Date: Jan. 28, 2016

(54) SINGLE FILTER CARTRIDGE FOR REMOVING CONTAMINATES FROM WATER

(71) Applicant: KOCH MEMBRANE SYSTEMS, INC., Wilmington, MA (US)

(72) Inventors: David M. Colby, Wilmington, MA (US); Taylor Johnson, Wilmington, MA (US)

(73) Assignee: KOCH MEMBRANE SYSTEMS, INC., Wilmington, MA (US)

(21) Appl. No.: 14/806,818

(22) Filed: Jul. 23, 2015

(30) Foreign Application Priority Data
Jul. 23, 2014 (CN) 201420410272.4

(51) Int. Cl. B01D 63/02

(52) U.S. Cl. CPC B01D 63/024; B01D 2313/143; B01D 2313/16; B01D 2313/26; B01D 2313/44; B01D 2319/04

(57) ABSTRACT

A single header filter cartridge for removing contaminates from water using a plurality of hollow fiber membrane filters, and methods of using the same, is provided. The single header filter cartridge contains a plurality of hollow fiber membrane filters secured at the top of the cartridge in a header to form a fiber bundle, the filter ends designed to be freely suspended in the water, a central aeration tube positioned at the cartridge bottom, and a vent tube positioned near the cartridge top that creates a void space within the fiber bundle.

### RELATED APPLICATIONS

This application claims priority to Chinese Utility Model Application No. 201420410272.4, herein incorporated by reference, filed on Jul. 23, 2014.

### TECHNICAL FIELD

The present invention relates to a single header filter cartridge for removing contaminates from water using a plurality of hollow fiber membrane filters, and methods of using the same. Specifically, the present invention is a single header filter cartridge with a plurality of hollow fiber membrane filters secured at the top of the cartridge in the header that form a fiber bundle, the filter ends designed to be freely suspended in the water, with a central aeration tube positioned at the cartridge bottom, and a vent tube near the top of the cartridge that creates a void space within the fiber bundle.

### BACKGROUND

Water filtration is an important and growing industry as the world searches for cleaner and safer sources of water. There are several devices for filtering water—charcoal filters, reverse osmosis, ultrafiltration, hollow fiber membrane filtration, and UV sterilization are just a few. Hollow fiber membrane filtration uses a plurality of hollow fiber membrane filters arranged in a bundle inside a cartridge. The fibers are secured on the top and bottom using a potting material. Dirty water typically enters the outside of the hollow fibers, while a vacuum is pulled on one side of the potting materials to draw the dirty water through the hollow fibers, thereby creating a clean permeate stream. This is called outside-in filtration, where the dirty water passes into the bore of the hollow fibers. There are several problems with such dual header design, namely membrane fouling. As the dirty water is pulled from the outside to the inside of the fiber, contaminates build up on the outside of the fibers, thereby decreasing filtration efficiency over time. Numerous methods have been used to loosen these contaminates during operation (e.g. shaking, ultrasonic cleaning, air scouring, reverse flushing), however, each has its limitations because of the dual header design.

From the above, the next logical step is to move to a single-header design as described in U.S. Pat. No. 4,002,567 to Konno. Konno describes a single-header design, where the fiber bundles are fixed at one end. In FIG. 2, the fibers are fixed at the bottom of the cartridge in a potting type material. The problem with this configuration is that sludge and contaminants can build up near the bottom, which affects filtration performance. This requires constant back-flushing to dislodge these contaminants.

WO2009/006850 to Meng discloses the opposite configuration—a single header design with the fiber bundle fixed at the top of the cartridge (See FIG. 2). The purpose here is for any contaminants to collect at the bottom of the cartridge to be flushed from the system (Abstract). Air bubbles can be introduced at the bottom of the cartridge to help dislodge particulates stuck on the fiber surfaces. (Page 7). The problem with this configuration is that the air bubbles can cause the fibers to fold or twist, thereby decreasing active cleaning area and preventing full dislodgment of contaminates from the fibers.

### SUMMARY OF THE INVENTION

There still remains a need in the industry for a single header filter cartridge design that overcomes the issues with constant back flushing and fiber folding/twisting. Thus, an object of the present invention is to provide a single header filter cartridge that contains a plurality of hollow fiber membranes potted at the top end with a central void space within the center of the plurality of hollow fiber membranes.

Surprisingly, it has been found that a single header design, where the hollow fiber membranes are potted only at the top of the filter cartridge and contain a void space, results in an efficient membrane cleaning system that is easy to clean during operation. This occurs because the membranes move more freely and the air from the aeration nozzle can more easily move between the individual fibers without twisting or folding, thereby scouring more contaminates off the surface of the fibers.

In one embodiment, the single header filter cartridge comprises:

a housing that comprises an inlet feed port for receiving dirty or contaminated water and a permeate port for removing clean water;

a plurality of hollow fiber membranes inside the housing and secured at a top end by a potting material to create a fiber bundle;

at least one aeration nozzle inside the housing and located at a bottom end of the housing that is opposite the top end;

at least one vent tube having a receiving end inside the housing and located near the top end, wherein the vent tube forms a void space in the center of the fiber bundle; and

at least one venting end outside the housing in fluid communication with the at least one vent tube, wherein the receiving end is configured to receive air from the aeration nozzle and the venting end is configured to discharge the air outside the housing.

In a preferred embodiment, the plurality of hollow fiber membranes has tips that are opposite the top end and are sealed.

In a further preferred embodiment, there are a plurality of vent tubes for receiving air from the aeration nozzle, wherein the plurality of vent tubes can have a single venting end outside the housing or a plurality of venting ends outside the housing.

In yet another preferred embodiment, a void spacer is located within the void space below the vent tube.

In another embodiment, a method of filtering contaminated water using the aforementioned single header filter cartridge is disclosed.

### DESCRIPTION OF THE DRAWINGS

FIG. 1 is a schematic of the internals of a prior art dual-header filter cartridge where the hollow membrane fibers are potted at both ends.

FIG. 2 is a schematic of the internals of a single header filter cartridge, where the hollow membrane fibers are potted at the top, the aeration nozzle is located at the bottom of the cartridge, and the vent tube creates a void space in the center of the fiber bundle.

FIG. 3 is a schematic of the internals of a single header filter cartridge, where a void spacer is located within the void space below the vent tube.

FIG. 4 is a schematic of the aeration and water flow inside the single header filter cartridge.

FIG. 5 is a schematic of the internals of a single header filter cartridge, where there is a plurality of vent tubes.

FIG. 6 is a schematic of the hollow fiber membrane resin tip seal.

FIG. 7 is a schematic of the outside of a single header filter cartridge.

### DETAILED DESCRIPTION

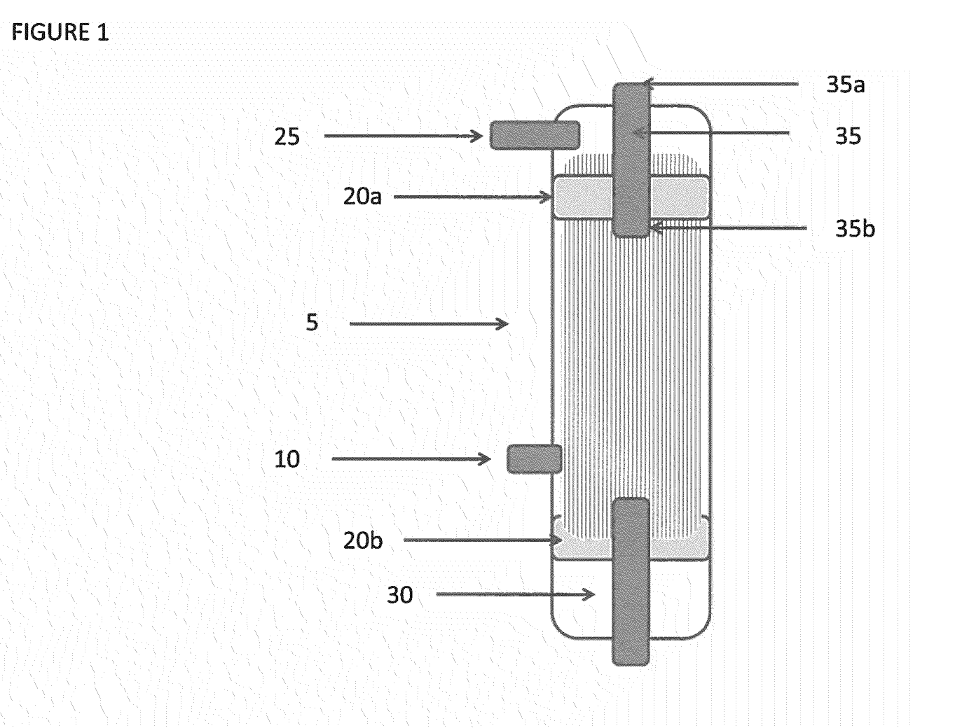

Referring now to the drawings in greater detail, FIG. 1 discloses a prior art system with a feed port 10 for introducing contaminated water into the filter cartridge 5. A plurality of hollow fiber membranes 15 are secured at both ends 20a and 20b with potting material (e.g. epoxy). Clean water or permeate is pulled from one end 25a, but could also be pulled from the opposite end (not shown). As described above, contaminates form on the outside of the fiber membranes and are difficult to remove because of the dual potting (or header) design.

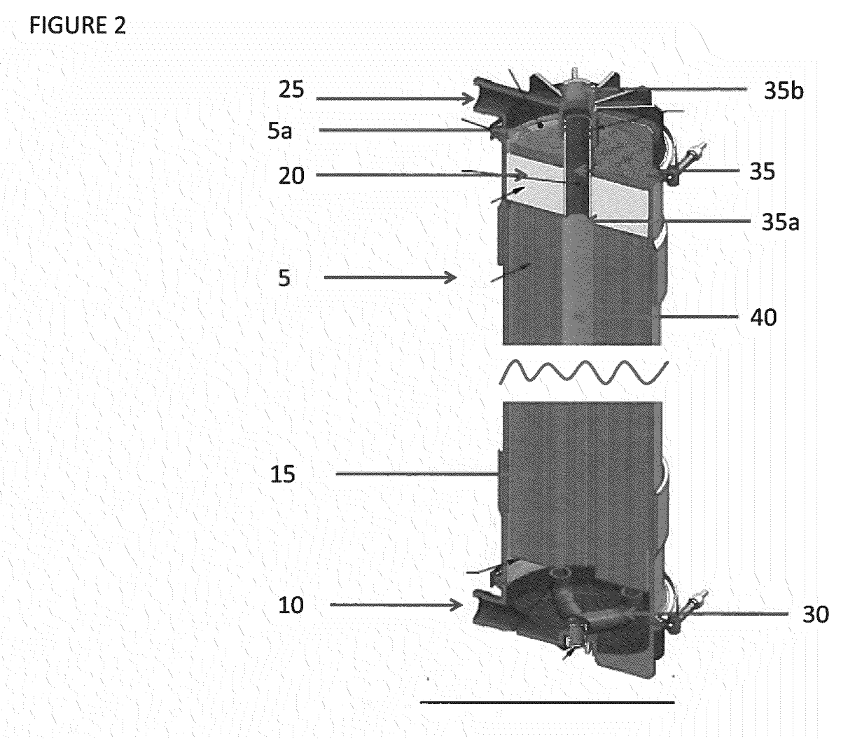

Referring to FIG. 2, in one embodiment a membrane filter cartridge housing 5 comprises a feed port 10 for receiving dirty or contaminated water that is located at the bottom end of the housing. A permeate port 25 is located at the top end of the housing and removes clean water from the filter cartridge. Inside the filter cartridge, a plurality of hollow fiber membranes 15 are arranged in a bundle configuration and potted 20 at the top of the filter cartridge housing 5. This forms a single header design. The aeration nozzle 30 is located at the bottom of the housing 5. Vent tube 35 is located near the top of the housing, and has a receiving end 35a for receiving air from the vent tube and a venting end 35b located outside the housing for discharging air outside the housing. The vent tube forms a void space 40 within the center of the fiber bundle.

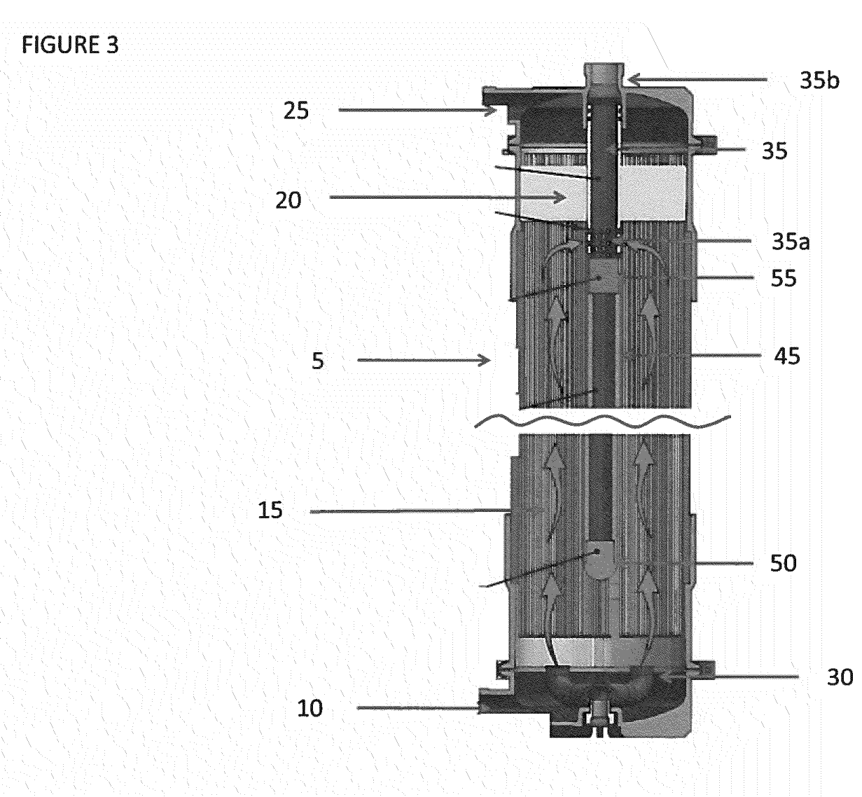

FIG. 3 discloses a preferred embodiment of the single header cartridge, where a void spacer 45 occupies the void space formed by the vent tube 35. The void spacer 45 further enhances the fiber anti-folding/twisting properties of the present invention. Moreover, the void spacer is beneficial during vigorous aeration, where the void space alone may not be sufficient to prevent the fibers from folding or twisting. If the void spacer is hollow, optional elements on the void spacer include stopper 50, which prevents air from entering the void spacer and plug 55, which prevents water from entering the void spacer. The void spacer can be made of any material (e.g. metal, plastic, ceramic, composite), but preferably is made from the same material as the vent tube or filter cartridge. When the void spacer is used, the vent tube receiving end 35a will contain one or a plurality of openings on the side of the receiving end to allow the air to enter the vent tube for discharge outside the cartridge. The void spacer can be integral with the vent tube or separated by plug 55. For example, the void spacer and vent tube can be one continuous piece of material, or individual pieces separated by plug 55. FIG. 3 also depicts the flow of aeration air through the fiber bundle and into the vent tube.

In certain embodiments, the vent tube 35 and venting end 35b need not be made from a single piece of material (i.e. there can be a gap between the vent tube and venting end). All that is required is that the vent tube 35 and venting end 35b be in fluid communication with one another, so air traveling through the vent tube can be discharged outside the cartridge housing.

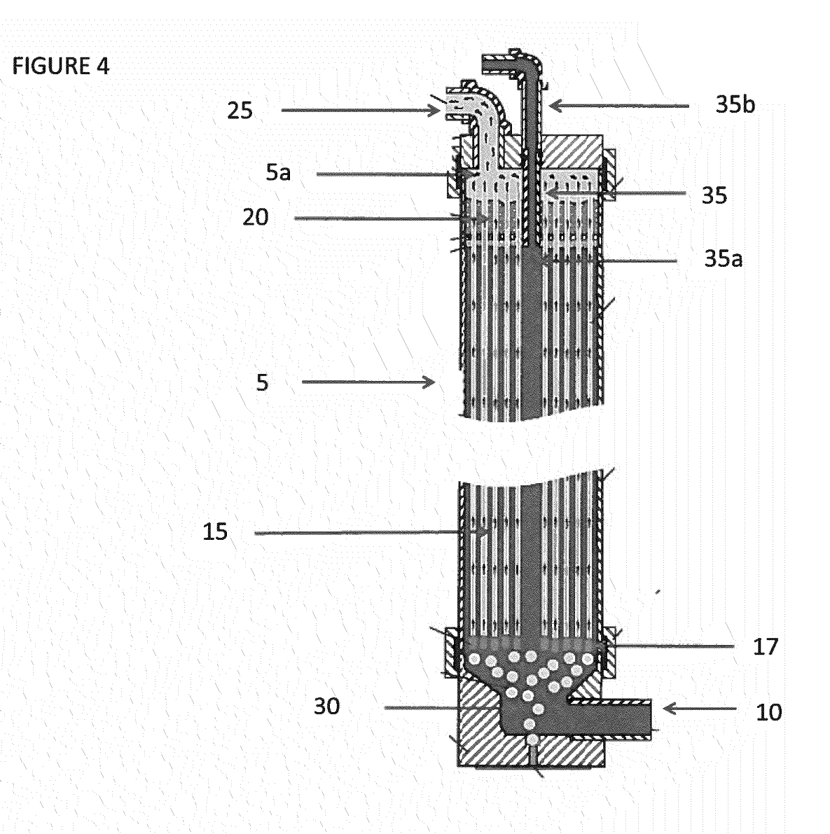

In other embodiments, the aeration nozzle need not be as disclosed in FIG. 2 or 3. Instead, the aeration nozzle can comprise a plurality of individual sparger elements, a single aeration element positioned in the center (FIG. 4), or a plurality of aeration tubes evenly spaced from the center of the bottom cartridge end.

Referring back to FIG. 2 and FIG. 4, during operation, dirty water enters the housing through feed port 10. Once the housing is full of dirty water, a vacuum is applied to the top of the housing 5a on the side that is opposite the potting material 20. The vacuum pulls the dirty water through the hollow membrane fibers 15 and out of the top of the housing 5a, whereby the contaminates contained in the dirty water are left on the outside of the fibers and clean water is on the inside of the fibers. The clean water is removed from the housing through the permeate port 25. Periodically, air is introduced into the housing through aeration nozzle 30. The air passes between the hollow fiber membranes 15 and moves up the housing from the bottom end to the top end. As the air moves up the housing, it scours (or removes) the contaminates from the outside of the membrane fibers. The contaminates fall to the bottom of the housing, where they settle out or are flushed out of the cartridge.

The hollow membrane fibers preferably comprise long cylindrical tubes having a hollow internal bore, a first end that is potted near the top end of the housing and a second end that is positioned near the bottom end of the housing. The single header cartridge of the present invention may be used with any type of hollow fiber membrane. For example, the hollow fiber membrane can have a diameter less than 5 mm, including between 0.5 and 3 mm, and 2.4 to 2.6 mm. The hollow fiber membrane may be a microfiltration membrane or ultrafiltration membrane. One preferred type of hollow fiber membrane is a braded-reinforced hollow fiber membrane.

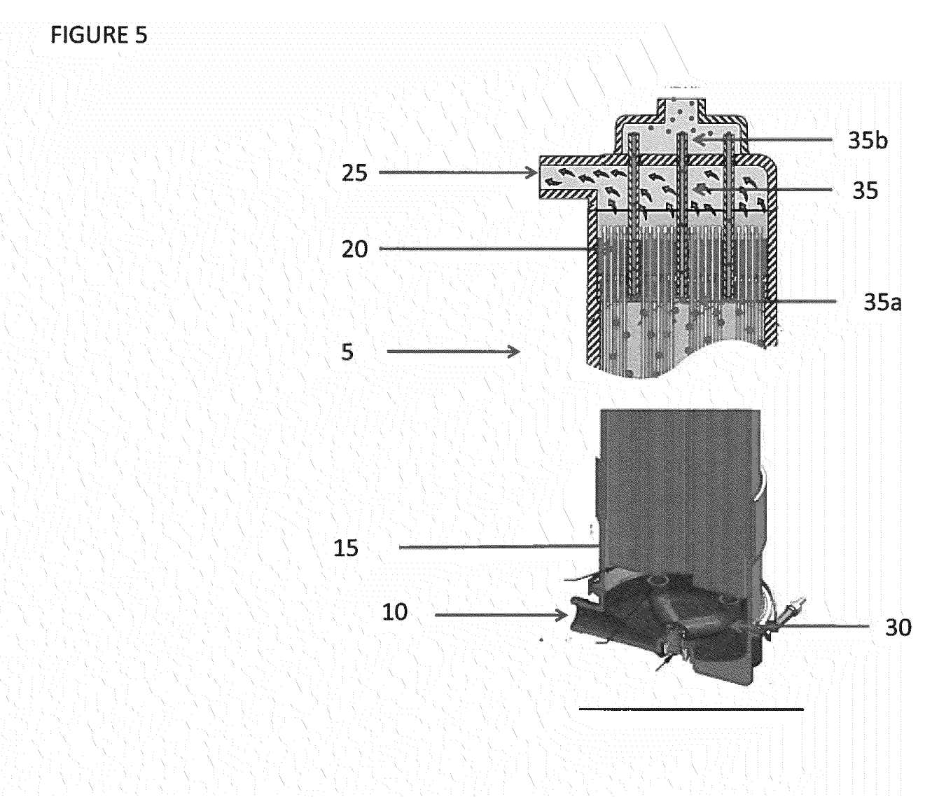

FIG. 5 discloses another embodiment with multiple vent tubes 35 that receive air from the aeration nozzle. In this embodiment, the multiple vent tubes all converge into a single venting end 35b. Conversely, the multiple vent tubes may each contain a venting end (not shown), or one venting end may service several, but not all, of the vent tubes (not shown).

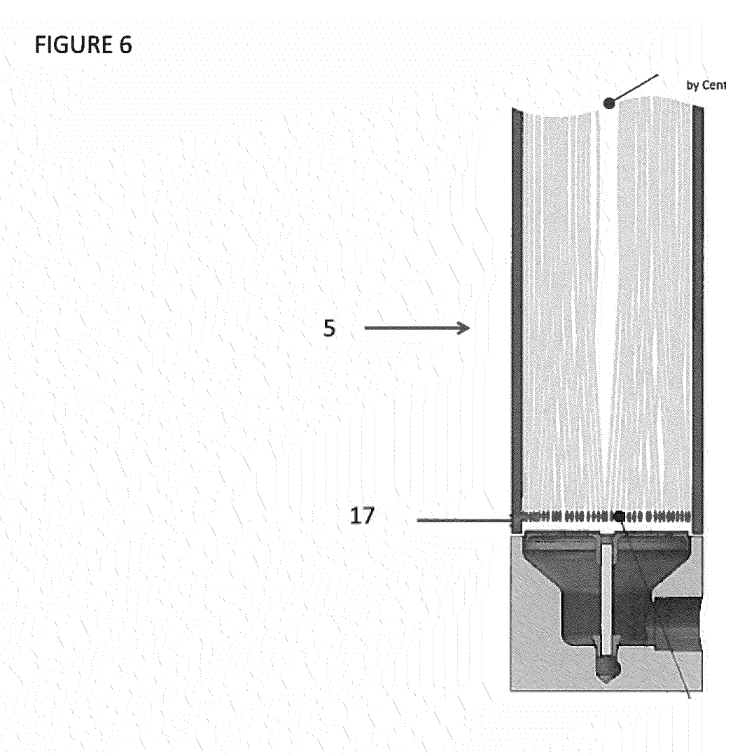

The fiber ends that are opposite the header (i.e. second end) must be sealed to allow for a pressure gradient to be applied on the fibers. The ends can be sealed using a conventional means, including pinching, folding, sowing, crimping, melting, and chemical sealants. For example, FIG. 6 discloses fiber ends that are sealed with a resin as disclosed in WO2013/138170 herein incorporated by reference in its entirety. Specifically, in one embodiment, the fiber ends are sealed with a light-curable adhesive, which preferably is a low viscosity adhesive. Use of a low viscosity adhesive forms a thin coating of adhesive on the exterior of the fiber and will flow into the internal bore of the fiber to form a plug. Examples of light-curable adhesives, include adhesives with a viscosity less than 5000 cps, including viscosities less than 2000 cps and between 100 and 1000 cps. One example of a preferred adhesive is an acrylated urethane.

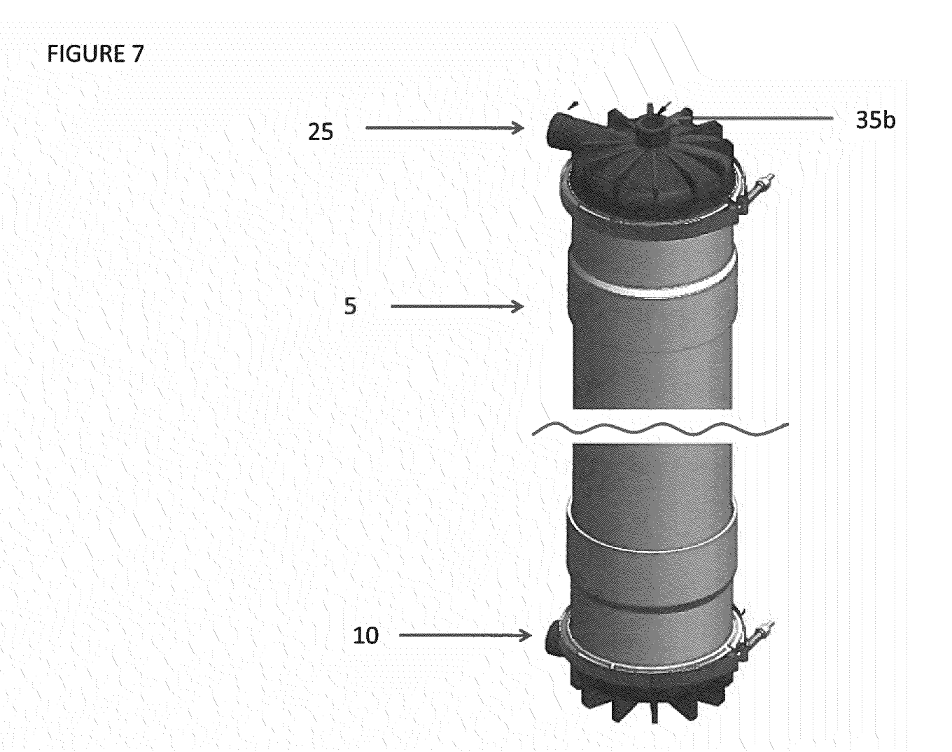

FIG. 7 discloses one embodiment of the outside of the single header filter cartridge.

### EXAMPLES

### Example 1

Compared to the prior art dual header design, the present invention has a much more stable transmembrane pressure (TMP) over the course of operation (i.e. standard aeration and backwashing intervals). TMP is a good measure of the amount of vacuum (pressure) that needs to be applied to pull the dirty water through the fibers. The lower the number, the less contaminates on the outside of the fibers. Stability in TMP shows the efficiency of cleaning the fibers. The table below shows the TMP over time for both the dual header design and the disclosed utility model, while keeping all other variables and feed water constant.

| | | Present Invention with |
|---|---|---|
| Time | Prior Art Cartridge | void space |
| Week 1 | 10 | 8 |
| Week 2 | 30 | 9 |
| Week 3 | 10 | 12 |
| Week 4 | 20 | 12 |
| Week 5 | 30 | 12 |
| Week 6 | 15 | 12 |
| Week 7 | — | — |
| Week 8 | 5 | 9 |
| Week 9 | — | 9 |
| Week 10 | — | 10 |
| Week 11 | 5 | 10 |
| Week 12 | 5 | 9 |
| Week 13 | 5 | — |
| Week 14 | 15 | — |
| Week 15 | 10 | 12 |
| Week 16 | 10 | 13 |
| Week 17 | 25 | 12 |
| Week 18 | 30 | 12 |

As shown above, the present invention not only had a more stable TMP but a lower TMP. This indicates that the cartridge has higher filtration performance and easier cleaning capability than the prior art. Thus, the single header filter cartridge of the present invention can have a transmembrane pressure of less than 15 after 18 weeks of operation, including less than 14, less than 13, and between 10 and 15. Further, the single header filter cartridge of the present invention can have a transmembrane pressure variation of less than 10 over 18 weeks of operation, including less than 7, less than 5, and between 5 and 10.

1. A single header filter cartridge comprising:
a housing that comprises an inlet feed port for receiving dirty or contaminated water and a permeate port for removing clean water;
a plurality of hollow fiber membranes inside the housing and secured at a top end of the housing by a potting material to create a fiber bundle;
at least one aeration nozzle inside the housing and located at a bottom end of the housing that is opposite the top end;
at least one vent tube having a receiving end inside the housing and located near the top end, wherein the vent tube forms a void space in the center of the fiber bundle; and
at least one venting end outside the housing in fluid communication with the at least one vent tube, wherein the receiving end is configured to receive air from the aeration nozzle and the venting end is configured to discharge the air outside the housing

2. The single header filter cartridge of claim 1, wherein the plurality of hollow fiber membranes has tips that are opposite the top end and are sealed.

3. The single header filter cartridge of claim 1, wherein there are a plurality of vent tubes for receiving air from the aeration nozzle.

4. The single header cartridge of claim 1 wherein the inlet feed port is located at the bottom end of the cartridge and the permeate port is located at the top end of the cartridge.

5. The single header filter cartridge of claim 2, wherein the plurality of hollow fiber membrane tips are sealed with a light curable adhesive.

6. The single header filter cartridge of claim 5, wherein the light curable adhesive has a viscosity less than 2000 cps.

7. The single header filter cartridge of claim 5, wherein the light curable adhesive has a viscosity between 100 and 1000 cps.

8. The single header filter cartridge of claim 1, wherein the venting end is adjacent the top end of the housing.

9. The single header filter cartridge of claim 1 wherein a void spacer is located in the void space.

10. The single header filter cartridge of claim 9, wherein the void spacer has a stopper disposed at one end to prevent air from entering the interior of the void spacer.

11. The single header filter cartridge of claim 9, wherein the void spacer has a plug disposed at one end to prevent fluid from entering the interior of the void spacer.

12. The single header filter cartridge of claim 9, wherein the void spacer has a plug disposed at one end to prevent fluid from entering the interior of the void spacer and a stopper at the opposite end to prevent air from entering the interior of the void spacer.

13. The single header filter cartridge of claim 9 wherein the void spacer interior can be solid or hollow.

14. The single header filter cartridge of claim 1 wherein the vent tube comprises at least one opening on the side of the receiving end to allow air to enter the vent tube for discharge outside the cartridge.

15. The single header filter cartridge of claim 9, wherein the vent tube and void spacer are integral.

16. The single header filter cartridge of one of claim 9, wherein the vent tube and void spacer are separated by a plug disposed near the receiving end of the vent tube.

17. The single header filter cartridge of claim 1, wherein the transmembrane pressure of the cartridge is less than 15 after 18 weeks of operation.

18. The single header filter cartridge of claim 1, wherein the transmembrane pressure variation of the cartridge is less than 10 over 18 weeks of operation.

19. The single header filter cartridge of claim 1, wherein the transmembrane pressure variation of the cartridge is less than 5 over 16 weeks of operation.
